(19) United States
(12) Patent Application Publication
(10) Pub. No.: US 2008/0073213 A1
(43) Pub. Date: Mar. 27, 2008

(54) Sieve Eop Pump

(75) Inventors: Rafael Taboryski, Bagsvaerd (DK); Simon Pedersen, Kobenhavn (DK); Jonatan Kutchinsky, Ballerup (DK); Claus Birger Sorensen, Dyssegard (DK)

Correspondence Address: BIRCH STEWART KOLASCH & BIRCH, PO BOX 747, FALLS CHURCH, VA, 22040-0747, US

(73) Assignee: SOPHION BIOSCIENCE A/S, BALLERUP (DK)

(21) Appl. No.: 10/546,261

(22) PCT Filed: Feb. 23, 2004
(86) PCT No.: PCT/IB04/01044

§ 371 Date: Mar. 9, 2007

(30) Foreign Application Priority Data
Feb. 21, 2003 (GB) 0303934.4

(51) Int. Cl. F04B 19/00; B01J 19/00

(52) U.S. Cl. 204/600; 430/314

(57) ABSTRACT

An electroosmotic flow pump for generating a flow in an electrolyte from an inlet to an outlet in a channel, the electroosmotic flow pump comprising a housing with the channel for holding the ionic solution, a membrane separating the channel in a first part in contact with the inlet and a second part in contact with the outlet, the membrane comprising a plurality of perforations having inner surface parts with a finite zeta potential in an 130-160 mM aqueous electrolyte with pH value in the interval 7-7.5, one or more first electrodes in electrical contact with electrolyte held in the first part of the channel and one or more second electrodes in electrical contact with electrolyte held in the second part of the channel, means for creating an electric potential difference between the first and second electrodes.

The present invention provides a pump for generating an electroosmotic flow (EOF) in a solution in a canal, guide, pipe or equivalent. Electroosmotic flow is generated by application of an electric field through a solution in a canal defined by insulating walls. More particularly, the invention provides an EOF pump design based on a perforated membrane (a sieve) in a canal with electrodes on both sides. The EOF pump can be readily integrated in small systems such as Microsystems, micromachines, microstructures etc. and allows for an efficient and easily controllable liquid flow in such systems.

According to the present invention, an electroosmotic flow in an ionic solution in a canal may be generated using an electrical field. In order to create the electroosmotic flow, the geometry as well as the materials of the canal have to be carefully chosen. It is an advantage of the present invention that it provides a pump for generating and controlling liquid flow in small flow systems. Moreover, the pump according to the invention may be fabricated using materials and processing technology typically used to fabricate small-scale systems and devices, such as chips, Microsystems, micromachines, microstructures, microfluidic systems, etc. The pump according to the invention may thereby be integrated in such small-scale systems and devices and provide an efficient and flexible liquid handling.

According to a first aspect of the present invention there is provided an electroosmotic flow pump for generating a flow in an iomic solution rom an inlet to an outlet in a canal, the electroosmotic flow pump comprising a housing within the canal for holding the ionic solution, a membrane separating the canal into a first part in contact with the inlet and a second part in contact with the outlet, the membrane comprising a plurality of perforations having inner surface parts with a finite zeta potential in an 130-160 mM aqueous electrolyte with pH value in the interval 7-7.5, one or more first electrodes in electrical contact with electrolyte held in the first part of the channel and one or more second electrodes in electrical contact with electrolyte held in the second part of the canal, means for creating an electric potential difference between the first and second electrodes, wherein the thickness of the membrane falls within the range of 2 to 200 μm, an average distance between any perforation and its closest neighbour is in the interval 2-100 μm, and the membrane comprises a material with a thermal conductivity in excess of 1.5 W m⁻¹ K⁻¹ at 25° C. and a surface oxide layer with a lower thermal conductivity than the material, the thickness of the oxide layer being smaller than the thickness of the material.

Preferably, the thickness of the membrane is in the interval 0.1-100 μm. Also, the number of perforations in the membrane is preferably in the interval 4-10000. In order to ensure a good pumping efficiency, radii of the perforations are preferably in the interval 0.1-5 μm. Further, an average distance between any perforation and its closest neighbour is in the interval 2-100 μm.

According to a second aspect of the present invention there is provided a membrane forming part of an electroosmotic flow pump according to the first aspect of the present invention.

According to a third aspect of the present invention there is provided a method of manufacturing an electroosmotic flow pump according to the first aspect of the invention, the method comprising the steps of forming the membrane with a predetermined number of perforations each having an inner radius of predetermined size such that in use of the pump, a maximum volumetric flow rate in excess of 1 n1 s ⁻¹ is obtained when the pump is driven at a driving voltage of less than 50V.

Preferred and advantageous features of the invention will become readily apparent from the appended dependent claims.

The invention will now be further described by way of example only with reference to the accompanying drawings in which:

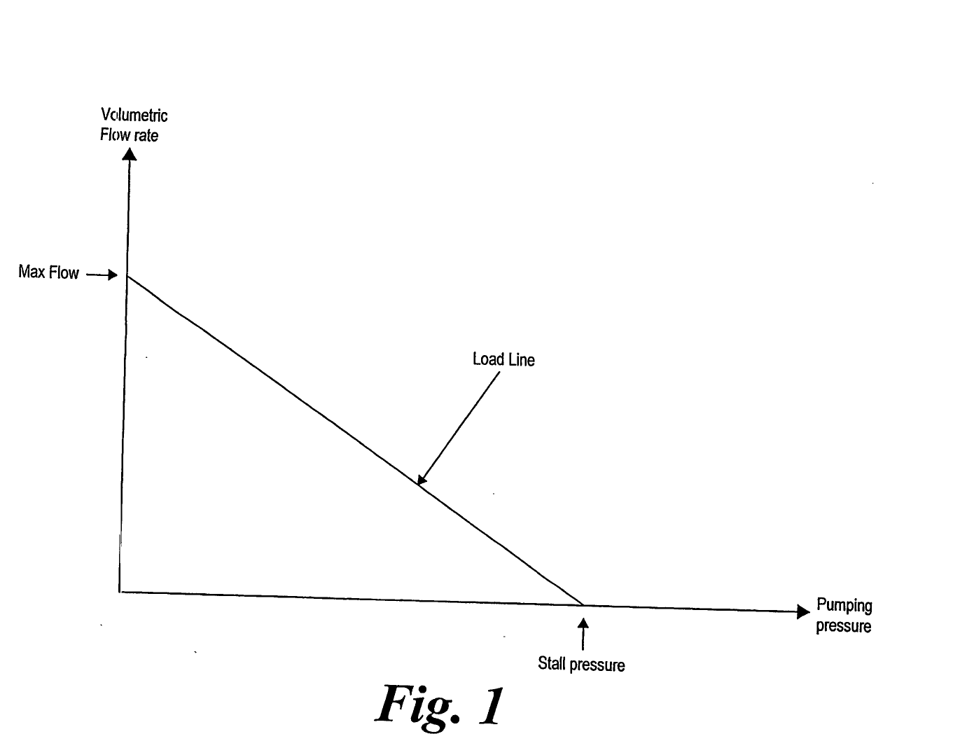

FIG. 1 shows the load line of an EOF pump with indications of the maximum volumetric flow rate and the stall pressure respectively;

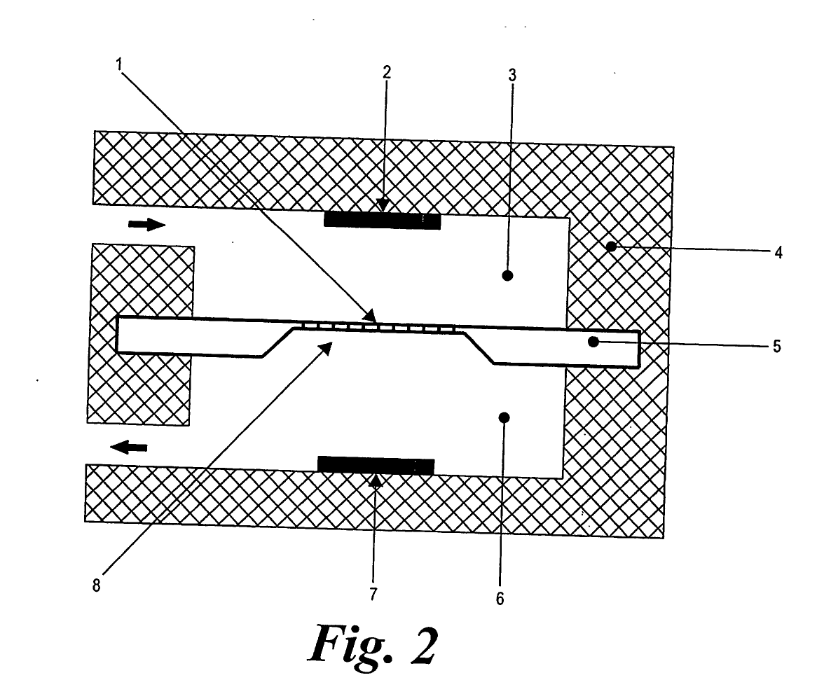

FIG. 2 is a schematic representation of an EOF sieve pump according to the present invention;

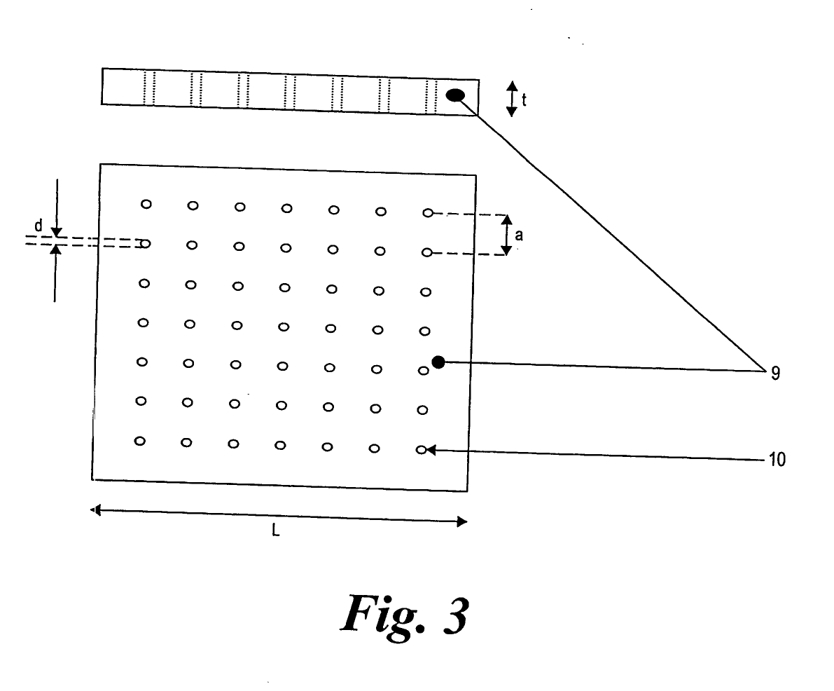

FIG. 3 is a detail of the membrane forming the EOF sieve pump of FIG. 2 showing the dimensions of the apertures;

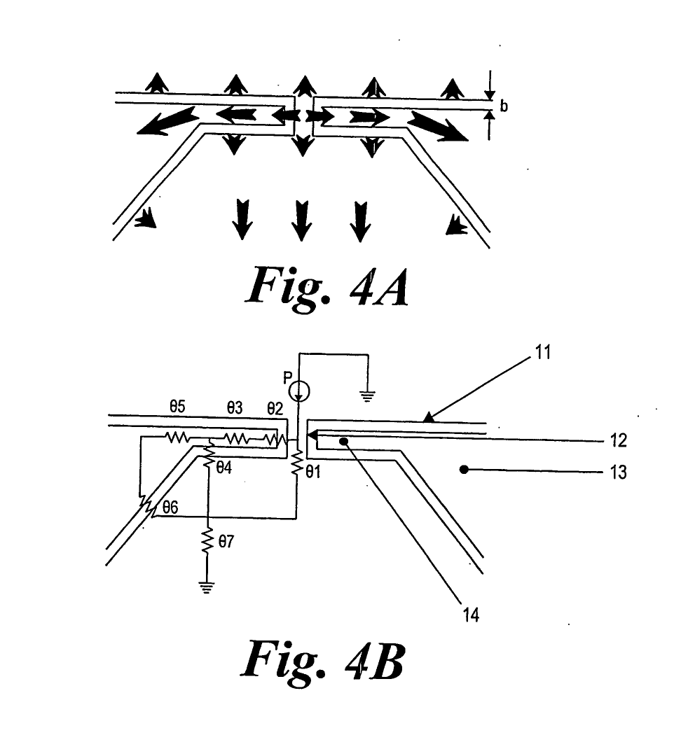

FIG. 4a is a schematic representation of the heat flow through an aperture forming part of the EOF sieve pump of FIG. 2;

FIG. 4b is an equivalent circuit for the heat sinking process in a preferred embodiment of the sieve pump forming part of the device shown in FIG. 2;

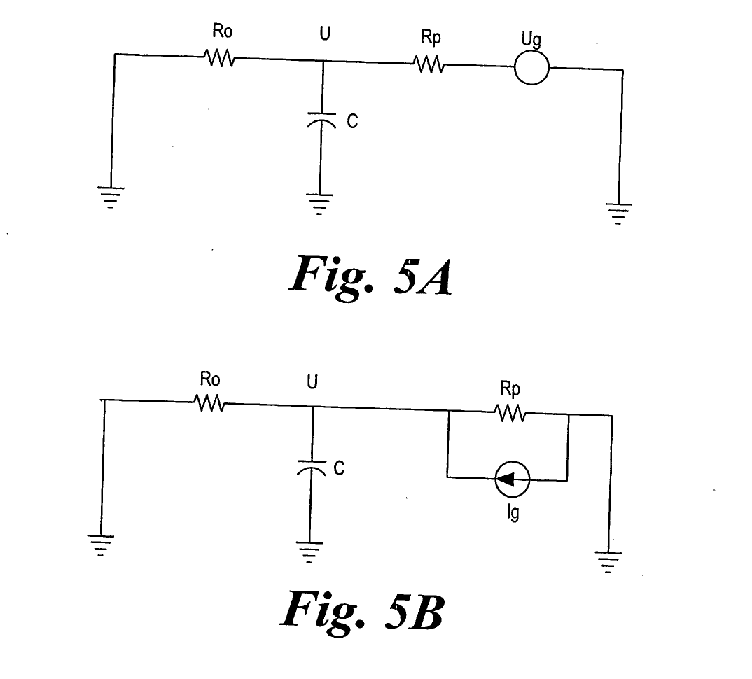

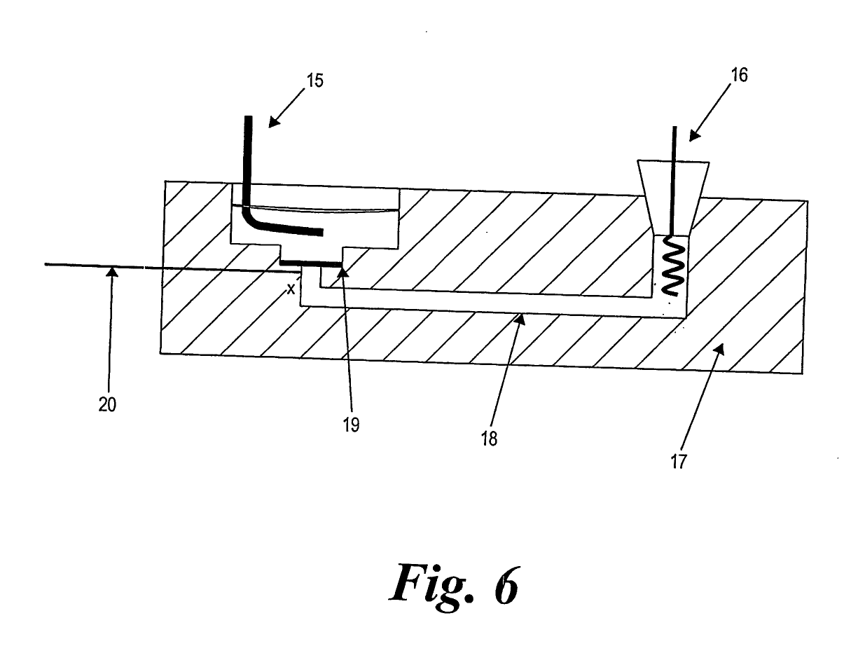

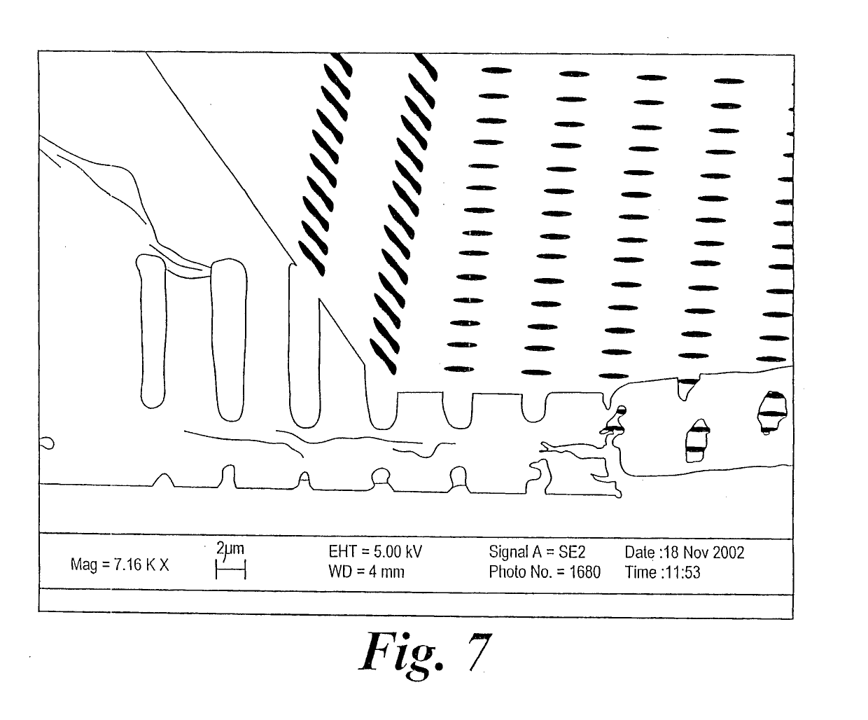

FIG. 5a and 5b are Thevenin and Norten circuits model equivalents respectively of the liquid flow system of the device of FIG. 2, with the load added, the load here being represented with the resistor R₀; FIG. 6 is a schematic representation of an EOF sieve pump according to the present invention assembled into a plastics housing; FIG. 7 is scanning electron micrograph of a membrane forming part of the pump of FIG. 2;

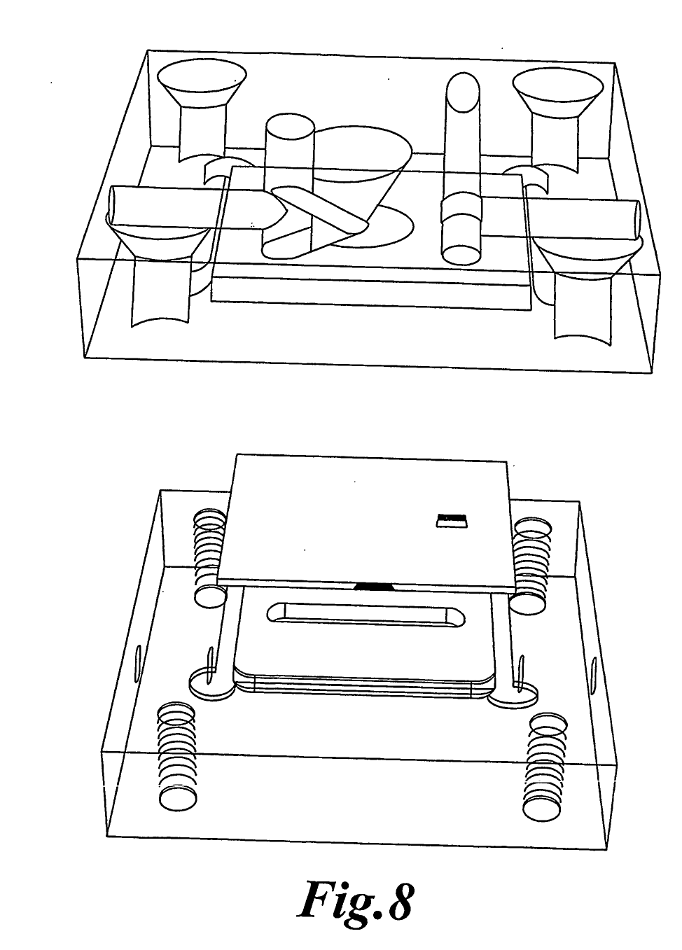

FIG. 8 is a 3 dimensional representation of the housing, gasket and chip of a particular embodiment of the present invention used for the benchmark testing;

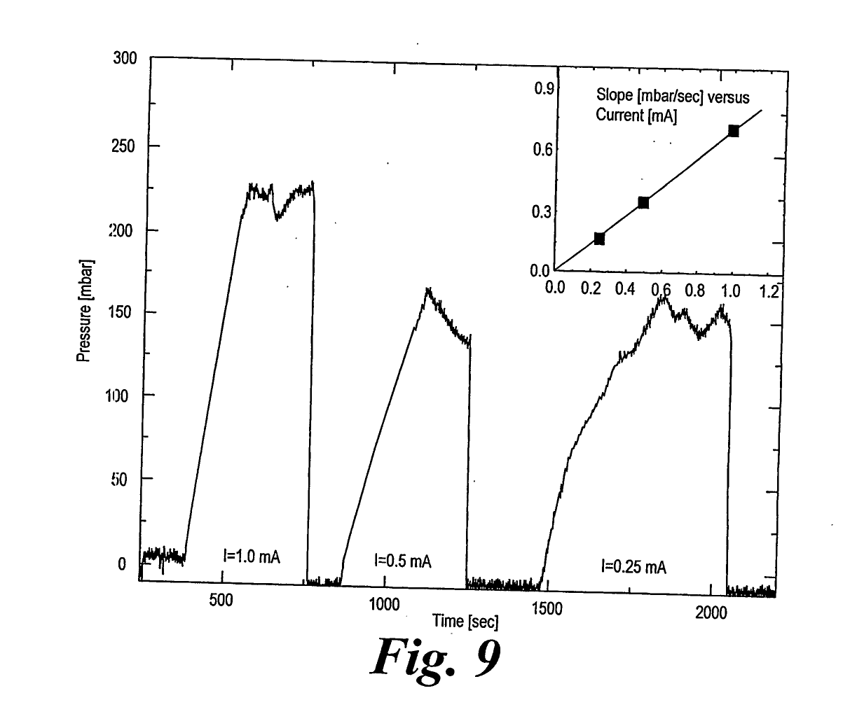

FIG. 9 is a graph showing the pressure of variation with time for an EOF sieve according to the present invention having 200 holes working at three different currents.

Electroosmotic flow (EOF) is generated by application of an electric field E across an electrolyte solution confined in a channel defined by insulating walls. The phenomenon arises due to the ionisation of sites on the insulating walls which causes a thin layer of mobile charges to accumulate within a thin layer given by the Debye length λ_{D}≈1−10 nm from the interface. When an electric field is applied to the solution an electric current will flow through the thin charge layer. Since the liquid/surface slip plane is located within the thin charge layer, the electrical current will also drag the fluid into motion. The charge density at the slip layer depends on the surface material (density of ionisable sites) and on the solution composition, especially pH and ionic concentration. The flow velocity is given by the Helmholtz-Smoluchowski equation:

$$v = \frac{ɛ ζ}{η} E , \qquad ( 1 )$$

where ε and η are the electrical permittivity and the viscosity of the electrolyte respectively and ζ (zeta) is the value of the electrical potential at the liquid/surface slip plane. However, although values for the zeta potential are often measured and published for material/solution combinations it is not really a readily controllable parameter. As it arises from the ionisation of surface sites, ζ and EOF are very susceptible to changes in surface condition and contamination. A value of 75 mV for ζ is given in the literature for a silica surface. For glass the values may be twice those for silica but for both the effects of pH and adsorbing species can in practice very significantly reduce the values. Such values for ζ may be used in design calculations, but it is wise to ensure that adequate performance is not dependant on it being achieved in practice. The direction of EOF is determined by the sign of the mobile charge in the solution generated by ionisation of the surface sites. As pKa for the ionisable groups on silica or silicate glass is ˜2, then at neutral pH values the surface is negatively charged and EOF follows the mobile positive ions towards a negatively polarized electrode. The volumetric flow rate Qₘₐₓ associated with electroosmotic flow for a flow channel of length L, and constant cross sectional area A is given by

$${Q}_{max} = \frac{A ɛ ζ}{L η} U , \qquad ( 2 )$$

where U is the driving voltage applied across the ends of the channel with length L and constant cross sectional area A. Eq. 2 defines the maximum possible flow rate an EOF pump can deliver with no load connected. The average velocity of the fluid particles in the channel is given by u=Q/A, and the electric field strength by E=U/L, allowing the definition of the electroosmotic mobility μ_{eof}=u/E=εζ/η to be independent of any particular geometry of the flow channel containing the EOF pump, and solely to characterize the interface between the liquid and the walls. With a load connected to the pump, the EOF driving force will be accompanied with a pressure driven flow (Poiseuille flow) counteracting the current induced flow. The volumetric flow associated with laminar Poiseuille flow is given by Qₘₐₓ=KΔp, where Δp is the pressure difference across each end of the flow channel, and K the flow conductance of the channel. The total flow rate is then given by

$$\frac{Q}{{Q}_{max}} = ( 1 - \frac{Δ p}{Δ {p}_{max}} ) . \qquad ( 3 )$$

The pressure compliance or stall pressure of the pump is given by:

$$Δ {p}_{max} = \frac{{Q}_{max}}{K} . \qquad ( 4 )$$

The derived pump characteristics are illustrated in FIG. 1. The overall performance of any particular EOF pump can be quantified by the product ΔpₘₐₓQₘₐₓ with unit of power. The higher the power, the better is the overall performance of the pump. If the pump is loaded with a flow conductance K_{load} at one end, and a reference pressure at the other end, the pressure difference across the load relatively to the reference pressure is given by:

$$Δ {p}_{load} = \frac{{Q}_{max}}{{K}_{load} + K} , \qquad ( 5 )$$

while the volumetric flow through the load is given by

Q_{load}=K_{load}Δp_{load}. (6)

A specific choice of pump configuration will give rise to an electrical conductance of the pump channel G. In response to the EOF driving voltage, the electrolyte inside the pump channel will carry the electrical current I. Design considerations associated with EOF pumps should comprise heat sinking due to the power dissipation in the pumps. Moreover, the location and design of electrodes should be considered to minimize the parasitic effects of series resistance generated either due to a long current path in the flow channels or due to contact resistance in between the electrodes and the electrolyte. In devices to be used for biomedical purposes, the natural choice of electrode material is Ag/AgCl, with the process (Ref. [1])

$$AgCl ( s ) {}^{\pm e} Ag ( s ) + {Cl}^{- 1} ( aq ) ,$$

and hence the consumption of such electrodes when operating the pump should be considered. The rate of consumption of electrode material expressed in volume per time unit is given by:

$$\frac{Δ V}{Δ t} = \frac{{I}_{q} {m}_{AgCl}}{e {N}_{A} {ρ}_{AgCl}} , \qquad ( 7 )$$

where m_{AgCl}=143.321 g/mol and p_{AgCl}=5.589 g/cm3 is the molar mass and the mass density of AgCl, while e=1.602×10⁻¹⁹ C and N_{A}=6.02×10²³ mol ⁻¹ is the elementary unit of charge and the Avogadro constant.

An alternative to the use of consumable electrodes involves the use of an external electrode linked to the chamber by an electrolyte bridge with high resistance to hydrodynamic flow. This might be a thin channel, similar to that providing the EOF pumping, but with a surface having low density of charged sites (low zeta potential) or where the surface has opposite polarity charge to the EOF pumping channel. In the latter case the low flow conductance channel to the counter electrode contributes towards the EOF pumping. Most wall materials tend, like glass or silica, to be negatively charged in contact with solutions at neutral pH. However it is possible to identify materials which bear positive charge. Alumina based ceramics may be suitable, especially if solutions are on the low pH side of neutral. Alternatively polymer or gel material, such as Agarose, polyacrylamide, Nafion, cellulose acetate, or other dialysis membrane-type materials may produce the bridge with high resistance to hydrodynamic flow. Preferably these should have low surface charge density or an opposite polarity to that of the EOF pumping channel.

The membrane material can in general be any material suitable for micropatterning, such as silicon, silicon nitride, glass, silica, alumina, aluminium, polymethyl-methacrylate, polyester, polyimide, polypropylene, or polyethylene. The pores in the membrane can be fabricated using laser milling, micro-drilling, sand blasting, with a high-pressure water jet, with photolithographic techniques, with a focused ion beam, or with other methods for micro-fabrication (Ref. [2]).

The surface of the membrane should be made hydrophilic by thermal or chemical oxidation, or by deposition of a hydrophilic material such as silicon oxide, glass, silica or alumina, for example through chemical vapour deposition. A preferred embodiment of the invention is shown in FIG. 2. The EOF pump comprises a membrane (8) with apertures that is defined on a silicon substrate using standard Micro Electro Mechanical Systems (MEMS) technology (Ref. [2]). The structure consists of a silicon substrate (5), a membrane (8), and apertures (1) defined lithographically and etched into the membrane. A preferred embodiment will also comprise a housing structure (4) defining, a first liquid compartment (3), a second liquid compartment (6), a first electrode (2) located in the first compartment, and a second electrode (7) located in the second compartment. A scanning electron micrograph of a preferred embodiment of the membrane (8) with apertures (1) is shown in FIG. 7. The membrane can for example be made through the following process:
1) The starting material is a silicon wafer with a 100 surface.
2) One surface of the silicon is coated with photoresist and the pattern containing the pore locations and diameters is transferred to the photoresist through exposure to UV light.
3) The pore pattern is transferred to the silicon with Deep Reactive Ion Etch (DRIE) or Advanced Silicon Etching (ASE) using an Inductively Coupled Plasma (ICP), resulting in deep vertical pores with a depth of 1-50 μm.
4) The silicon surface is coated with silicon nitride using Low Pressure Chemical Vapour Deposition (LPCVD).
5) The opposite side of the wafer (the bottom side) is coated with photoresist and a pattern containing the membrane defining openings in the silicon nitride is transferred to the photoresist through exposure to UV light.
6) The silicon nitride is etched away on the bottom side of the wafer in the regions defined by the openings in the photoresist, using Reactive Ion Etch (RIE).
7) The wafer is etched anisotropically in a KOH solution, resulting in a pyramidal opening on the bottom side of the wafer. The timing of the etching defines the thickness of the remaining membrane of silicon at the topside of the wafer. Alternatively boron doping can be used to define an etch stop, giving a better control of the thickness.
8) The silicon nitride is removed through wet chemical etching, for example in phosphoric acid at 160° C.
9) The silicon is coated with silicon oxide, either through thermal oxidation, with plasma enhanced chemical vapor deposition (PECVD) or with LPCVD.

Alternatively the substrate can be fabricated through the following process:
1) The starting material is a silicon wafer with a 100 surface.
2) The silicon surface is coated with silicon nitride using Low Pressure Chemical Vapor Deposition (LPCVD).
3) The bottom side of the wafer is coated with photoresist and a pattern containing the membrane defining openings in the silicon nitride is transferred to the photoresist through exposure to UV light.
4) The silicon nitride is etched away on the bottom side of the wafer in the regions defined by the openings in the photoresist, using Reactive Ion Etch (RIE).
5) The wafer is etched anisotropically in a KOH solution, resulting in a pyramidal opening on the bottom side of the wafer. The timing of the etching defines the thickness of the remaining membrane of silicon at the topside of the wafer. Alternatively boron doping can be used to define an etch stop, giving a better control of the thickness. Alternatively the silicon can be etched through the entire thickness of the wafer, leaving only the silicon nitride on the top surface as a thin membrane.
6) The top surface of the wafer is coated with photoresist and the pattern containing the pore locations and diameters is transferred to the photoresist through exposure to UV light.
7) The pore pattern is transferred to the silicon with Deep Reactive Ion Etch (DRIE) or Advanced Silicon Etching (ASE) using an Inductively Coupled Plasma (ICP), resulting in deep vertical pores with a depth of 1-50 μm.
8) The silicon is coated with silicon oxide, either through thermal oxidation, with plasma enhanced chemical vapor deposition (PECVD) or with LPCVD.

Alternatively the substrate can be fabricated through the following process:
1) The starting material is a silicon-on-insulator (SOI) wafer with a 100 surface, and a buried oxide layer located 1-50 μm below the top surface.
2) The wafer surface is coated with silicon nitride using Low Pressure Chemical Vapor Deposition (LPCVD).
3) The bottom side of the wafer is coated with photoresist and a pattern containing the membrane defining openings in the silicon nitride is transferred to the photoresist through exposure to UV light.
4) The silicon nitride is etched away on the bottom side of the wafer in the regions defined by the openings in the photoresist, using Reactive Ion Etch (RIE).
5) The wafer is etched anisotropically in a KOH solution, resulting in a pyramidal opening on the bottom side of the wafer. The buried oxide layer will serve as an etch stop for the anisotropic etch, resulting in a membrane thickness defined by the depth of the oxide layer.
6) The top surface of the wafer is coated with photoresist and the pattern containing the pore locations and diameters is transferred to the photoresist through exposure to UV light.
7) The pore pattern is transferred to the silicon with Deep Reactive Ion Etch (DRIE) or Advanced Silicon Etching (ASE) using an Inductively Coupled Plasma (ICP), resulting in deep vertical pores down to the depth of the buried oxide layer.
8) The exposed regions of the buried oxide layer are removed through RIE, wet hydrofluoric acid (HF) etch, or HF vapor etch. This will ensure contact between the top and bottom openings in the wafer.
9) The silicon is coated with silicon oxide, either through thermal oxidation, with plasma enhanced chemical vapor deposition (PECVD) or with LPCVD.

Alternatively the substrate can be fabricated through the following process:
1) The starting material is a silicon-on-insulator (SOI) wafer with a buried oxide layer located 1-50 μm below the top surface.
2) The bottom side of the wafer is coated with photoresist and a pattern containing the membrane defining openings in the silicon is transferred to the photoresist through exposure to UV light.
3) The membrane pattern is transferred to the silicon with Deep Reactive Ion Etch (DRIE) or Advanced Silicon Etching (ASE) using an Inductively Coupled Plasma (ICP), resulting in vertical cavities down to the depth of the buried oxide layer.
4) The top surface of the wafer is coated with photoresist and the pattern containing the pore locations and diameters is transferred to the photoresist through exposure to UV light.
5) The pore pattern is transferred to the silicon with Deep Reactive Ion Etch (DRIE) or Advanced Silicon Etching (ASE) using an Inductively Coupled Plasma (ICP), resulting in deep vertical pores down to the depth of the buried oxide layer.
6) The exposed regions of the buried oxide layer are removed through RIE, wet hydrofluoric acid (HF) etch, or HF vapor etch. This will ensure contact between the top and bottom openings in the wafer.
7) The silicon is coated with silicon oxide, either through thermal oxidation, with plasma enhanced chemical vapor deposition (PECVD) or with LPCVD.

Alternatively the substrate can be fabricated through the following process:
1) The starting material is a thin polymer sheet, for example made of polymethyl-methacrylate, polyester, polyimide, polypropylene, epoxy, or polyethylene, and with a thickness of 5-100 μm.
2) The sheet substrate should be suspended on a frame of plastic or other suitable material.
3) Pores in the substrate are fabricated using laser milling, micro drilling, sand blasting, or with a high-pressure water jet.
4) The substrate is coated with silicon oxide, glass or silica, at least in a region around the pores, through a low energy plasma enhanced chemical vapor deposition process.

Alternatively the substrate can be fabricated through the following process:
1) The starting material is a thin sheet of UV curing epoxy or acrylic, for example SU-8. The sheet should have a thickness of 5-100 μm.
2) The sheet substrate should be suspended on a frame of plastic or other suitable material.
3) The substrate is exposed to UV light through a standard photolithography glass mask with the pattern containing the pore locations and diameters.
4) The substrate is submerged in a developing solvent which removes the substrate polymer in the regions which were not exposed to UV light, resulting in pores penetrating the thin sheet.
5) The substrate is coated with silicon oxide, glass or silica, at least in a region around the pores, through a low energy plasma enhanced chemical vapor deposition process.

Alternatively the substrate can be fabricated through the following process:
1) The starting material is a glass wafer, for example Pyrex or borosilicate.
2) The bottom side of the wafer is coated with photoresist and a pattern containing the membrane defining openings is transferred to the photoresist through exposure to UV light.
3) The glass is etched away on the bottom side with HF vapor, or with HF in an aqueous solution while the front side is protected, thinning down the wafer to a thickness of 2-50 μm in selected regions.
4) The top surface of the wafer is coated with photoresist and the pattern containing the pore locations and diameters is transferred to the photoresist through exposure to UV light.
5) The pore pattern is transferred to the silicon with Deep Reactive Ion Etch (DRIE) or Advanced Oxide Etching (AOE) using an Inductively Coupled Plasma (ICP). This should result in deep vertical pores down to the depth of the cavity opened from the bottom side, ensuring contact between the two sides of the wafer.

Alternatively the substrate can be fabricated through the following process:
6) The starting material is a glass wafer, for example Pyrex or borosilicate.
7) The bottom side of the wafer is coated with photoresist and a pattern containing the membrane defining openings is transferred to the photoresist through exposure to UV light.
8) The glass is etched away on the bottom side with HF vapor, or with HF in an aqueous solution while the front side is protected, thinning down the wafer to a thickness of 2-50 μm in selected regions.
9) The top surface of the wafer is bombarded with a focused ion beam in a pattern defining the pore locations and diameters, weakening the glass material in these regions.
10)The wafer is etched with HF vapor, or with HF in an aqueous solution. The regions exposed to the focused ion beam will etch significantly faster than the rest of the wafer, resulting in pores forming between the top surface and the cavity opened from the bottom side, ensuring contact between the two sides of the wafer.

Alternatively the substrate can be fabricated through the following process:
11) The starting material is a glass wafer, for example Pyrex or borosilicate.
12)The bottom side of the wafer is coated with photoresist and a pattern containing the membrane defining openings is transferred to the photoresist through exposure to UV light.
13)The pattern is transferred to the glass with Deep Reactive Ion Etch (DRIE) or Advanced Oxide Etching (AOE) using an Inductively Coupled Plasma (ICP). This defines membranes in the top surface of the wafer, which should have a thickness of 2-100 μm.
14)The top surface of the wafer is coated with photoresist and the pattern containing the pore locations and diameters is transferred to the photoresist through exposure to UV light.
15)The pore pattern is transferred to the silicon with Deep Reactive Ion Etch (DRIE) or Advanced Oxide Etching (AOE) using an Inductively Coupled Plasma (ICP). This should result in deep vertical pores down to the depth of the cavity opened from the bottom side, ensuring contact between the two sides of the wafer.

The following model calculation deals with the performance of a preferred embodiment of the sieve electro-osmotic flow pump made with silicon processing technology. Included in the calculation, is the performance of the pump when loaded with an asserted flow conductance of an orifice for patch clamping. The thermal and dynamic properties of pumps, together with the electrode consumption times of pumps with a different number of holes, are estimated. In the calculation it is asserted, that the pump under consideration is connected to the load by means of a flow channel containing an electrolyte. For the estimations of the pressure compliance of the pump, the presence of an air bubble in the connecting channel and in contact with compliant housing materials (4) is assumed. In the model calculations a conceptual analogy between the transport phenomena for charge, liquid volume and heat is exploited. The relevant transport parameters are shown in Table 1.

TABLE 1
Analogies between transport phenomena

| Electrical | | |
|---|---|---|
| circuits | Laminar Poiseuille flow | Heat transfer |
| Electronic | Volume [m³] | Energy [J] |
| charge [C] | | |
| Current [A] | Volumetric flow rate [m³/s] | Heat flow [W] |
| Voltage [V] | Pressure difference [Pa] | Temperature difference [K] |
| Resistance [Ω] | Flow resistance [Pa s/m³] | Thermal resistance [K/W] |
| Capacitance [F] | Compliance [m³/Pa] | Heat capacity [J/K] |

TABLE 2
Fundamental constants used

| Constant | Symbol | Value |
|---|---|---|
| Boltzmann constant | k_{B} | 1.38 × 10⁻²³ J K⁻¹ |
| Electron charge | e | 1.60 × 10⁻¹⁹ C |
| Vacuum permittivity | ε₀ | 8.85 × 10⁻¹² F/m |
| Avogadro constant | N_{A} | 6.02 × 10²³ mole⁻¹ |

TABLE 3
Asserted buffer solution (electrolyte)
characteristics in the model calculations

| Property | Symbol | Value |
|---|---|---|
| Electrical | σ(T) = σ₀(1 + a₁(T − T₀) + | a₁ = 2.0022 · 10⁻² K⁻¹ |
| conductivity | a₂(T − T₀)² + a₃(T − T₀)³) | a₂ = 5.30 · 10⁻⁵ K⁻² |
| Ref. [7] | | a₃ = −3.71 · 10⁻⁷ K⁻³ |
| | | σ₀ = 0.016419 S/cm |
| Mass density | ρ | 1.0 kg/l |
| Thermal | k(T) = | k0 = 607.53 mWm⁻¹K⁻¹ |
| conductivity | k₀ + k₁(T − T₀) + k₂(T − T₀)² | k1 = 1.66 mWm⁻¹K⁻² |
| Ref. [8] | | k2 = −0.00973 mWm⁻¹K⁻² |
| Specific heat | cp | 4.2 Jg⁻¹K⁻¹ |
| Thermaldiffusivity | $γ = \frac{k}{{c}_{p} ρ}$ | 1.43 × 10⁻⁷ m²/s |
| ViscosityRef. [9] | $η ( T ) = {η}_{0} + {η}_{1} exp ( - \frac{( T - {T}_{0} )}{{T}_{1}} )$ | η₀ = 0.24163 · 10⁻³ Pa sη₁ = 1.54332 · 10⁻³ Pa sT₁ = 29.30K |
| Dielectric | ε | 78.58 ε₀ |
| constant | | |
| Ionic | n₀ | 150 mM |
| concentra- | | |
| tion | | |
| Temperature | T₀ | 298.15 K (25° C.) |
| Com- | κ | 4.6 × 10⁻¹⁰ Pa⁻¹ |
| pressibility | | |

TABLE 4
Asserted thermal conductivities for the substrate and membrane

| Property | Symbol | Value |
|---|---|---|
| Thermal conductivity SiO₂ | kₒₓ | 1.5 W m⁻¹ K⁻¹ |
| Thermal conductivity of bulk | k_{Si} | 190 W m⁻¹ K⁻¹ |
| crystalline Si (undoped) | | |

TABLE 5
Asserted interface properties of buffer solution and SiO2

| Property | Symbol | Value |
|---|---|---|
| Slip layer thickness in buffer | $λ = \sqrt{\frac{{ɛk}_{B} T}{{e}^{2} {n}_{0}}}$ | 1.1 nm |
| solution (Debye length) | | |
| Zeta potential | ζ | 15 mV |
| Electro osmotic mobility | μ_{EOF} | 1.17 × 10⁻⁴ cm² V⁻¹ s⁻¹ |

The overall pumping properties of the sieve pump depends crucially on the geometry and the surface properties of the material. The number of apertures can be used to adjust the maximum volumetric flow to a desired value, while the pressure compliance does not depend on the number of apertures. In the calculation it is assumed that a fully developed laminar flow pattern is established in each of the apertures, and that the aperture length is much longer than the width, in order for the pipe flow approximation to apply. The preferred fabrication method will allow aperture diameters and aperture length to be made according to the specified values.

The aperture length (membrane thickness), the aperture diameter, and the pitch size in the array of pores are shown in FIG. 3. In FIG. 3 (9) is the membrane of thickness t and side length L, (10) is one of the apertures with diameter d. The pitch size is denoted a. The pumping capability does not explicitly depend on the pitch size. The number of pores is denoted N, while U is the driving voltage. A summary of the important parameters is given in Table 6.

TABLE 6
Expressions for calculating the pumping capability

| | |
|---|---|
| Flow conductance of pump | $K = N \frac{ π {( \frac{d}{2} )}^{4}}{8 η t}$ |
| Maximum flow, when no load is connectedto the pump. | ${Q}_{max} = \frac{N {π ( \frac{d}{2} )}^{2}}{t \cdot } {μ}_{eof} U$ |
| Pressure compliance (stall pressure) | ${Δp}_{max} = \frac{{Q}_{max}}{K} = \frac{32 {ημ}_{eof} U}{{d}^{2}}$ |

The thermal properties of the pump relate to the fact that operation of any electro osmotic flow pump is associated with generation of Joule heat. In the pump design the apertures represent the highest electrical resistance to the current flow from anode to cathode, and hence it is in the apertures that Joule heat is primarily generated. A good pump design should allow for this heat to be heat sunk, otherwise boiling of the liquid in the pores may result. The Joule heat may either be removed by advection through liquid flow in the pores or by thermal conduction in the membrane material. A way to estimate the dominating heat transfer process is to calculate the so called Péclet number, which is a dimensionless number expressing the relative magnitude of the heat advection term to the heat conduction term in the heat transfer equation for a flow channel. A small Péclet number means that liquid flow through the pores has negligible influence compared to heat conduction through the channel walls on removal of Joule heat from the interior of the pores. The Péclet number is given by (Ref [3])

$$Pe = \frac{vd}{γ} , \qquad ( 8 )$$

where v is the average flow velocity in the pores. For a typical pore diameter of <1 μm and a pore length of 10 μm the flow velocity will be less than 1 mm/s. This gives a Péclet number of the order of 10⁻³, which clearly indicates that conduction is by far dominating over advection in the heat transfer process. One may thus neglect any advection terms in the heat sinking calculations.

The heat flow of the pump of FIG. 2 is illustrated in FIG. 4A. FIG. 4B shows the equivalent circuit for the heat sinking process in a preferred embodiment of the sieve pump, where (12) is one of the apertures, (14) the membrane, (13) the substrate, and (11) the SiO surface coating of thickness b. In the model calculations, all the apertures are treated independently, so that the resulting thermal resistance is found by taking a parallel connection of all the apertures. Moreover, it is assumed that the separation of the pores (a) is chosen large enough in order spatially to ensure thermal equilibrium on the membrane. In other words, the thermal healing length should not be larger than about half the pitch size. The thermal resistances identified for the preferred embodiment are listed below. The expressions can be derived from formulas in Ref. [4]

TABLE 7
Contributions to the thermal resistance

| | |
|---|---|
| Thermal resistance of liquid inside pores.Pore diameter d, pore length t. | ${θ}_{1} = \frac{t / 2}{k π {( d / 2 )}^{2}}$ |
| Thermal resistance of the oxide layer insidethe pore. Oxide thickness b. | ${θ}_{2} = \frac{ln ( 1 + 2 b / d )}{2 {πk}_{ox} t}$ |
| Thermal resistance of silicon enclosing the pore.Pitch size a. | ${θ}_{3} = \frac{ln ( \frac{a / 2}{b + d / 2} )}{2 {πk}_{si} t}$ |
| Thermal resistance of oxide in membrane.Membrane side length L. | ${θ}_{4} = \frac{b}{{L}^{2} {k}_{ox}}$ |
| Thermal resistance of bulk Si.Side length of substrate die Ldie, thickness ofsubstrate tdie. | ${θ}_{5} = \frac{ln ( {L}_{die} / L )}{2 {πk}_{Si} {t}_{die}}$ |
| Thermal resistance of oxide on substrate.Area of die liquid interface A. | ${θ}_{6} = \frac{b}{{Ak}_{ox}}$ |
| Thermal resistance of connecting flow channel.Height of flow channel h | ${θ}_{7} = \frac{h}{Ak}$ |
| Dissipated power in pump pores | $P = \frac{N π {( \frac{d}{2} )}^{2}}{{t}_{m}} {σU}^{2}$ |

By forming the parallel connection of the N apertures, the resulting thermal resistance can be found.

$${θ}_{res} = {θ}_{7} + {[ \frac{1}{( {θ}_{2} + {θ}_{3} ) / N + {( {θ}_{4}^{- 1} + {( {θ}_{5} + {θ}_{6} )}^{- 1} )}^{- 1}} + \frac{N}{{θ}_{1}} ]}^{- 1} \qquad ( 9 )$$

The dissipated power depends on the applied driving voltage and the electrical conductance across the pump, which is limited by the conductance of the pump pores. If the power P is dissipated as Joule heat in the pump, the resulting temperature rise in the pores can be found from

ΔT=θᵣₑₛP, (10)

in a self consistent calculation where the temperature dependence of the electrical conductivity, the thermal conductivity and the viscosity of the electrolyte is taken into account. For feasible values of the geometrical parameters corresponding to the preferred embodiment of the pump, it can be found that the conduction through the oxide layer in the pores θ₂ constitutes the bottleneck for the heat conduction, while the heat flow through the liquid plays a much smaller role.

Another advantage associated with an EOF pump is that a low driving voltage is required to achieve a required stall pressure. If the pump in particular can be operated with driving voltages below 50 V, it will ease the requirements for the control circuit, and minimise the safety hazards. Advantageously, a low driving voltage will also reduce the dissipated Joule heat in the device.

In conclusion, an effective heat sinking is strongly facilitated if the membrane is thick, the surface oxide layer thin, and the bulk part of the membrane consists of a material with high thermal conductivity, preferably much higher than the thermal conductivity of the surface oxide layer. In FIGS. 5A and 5B are shown the Thevenin and Norton circuits model equivalents of the flow system comprising the EOF pump (Ref. [5]). These equivalent models may be used to find the transfer function for transient response of the voltage U across the load, when a pulse is applied from the generator. In other words, the model can be used to identify the limiting time constant for operation of the pump together with a load. The voltage U represents the pressure drop across the load. R₀ represents the flow resistance of the load, while Rₚ represents the flow resistance of the pump. The voltage generator U_{g} represents the max (stall) pressure of the pump, while the current generator I_{g} represents the maximum volumetric flow. When using the Thevenin equivalent circuit (FIG. 5A) the pump is represented by U_{g} in series with Rₚ, while in the Norton equivalent circuit (FIG. 5B) the pump is represented by I_{g} in parallel with Rₚ. The capacitor represents the pressure compliance of the system. However, since the contributions to C can come from gas bubbles in the system, the capacitor can be voltage (pressure) dependent. This voltage (pressure) dependence introduces a non-linearity in the system but is taken into account in the calculation. If the load Rₒ is much larger than Rₚ, the dominating time constant in the pressure transfer function U/U_{g} for the Thevenin equivalent circuit, will be given by τₚ=RₚC. Three contributions to C can readily be identified, namely the one due to the compressibility of the liquid in the connecting channel, the one resulting from the presence of parasitic air bubbles in the flow channel connecting the pump and the load and the one due to the presence of compliant housing material in contact with the connecting channels. Other contributions may also be taken into account, but are neglected in the present calculation.

TABLE 8
Contributions to the pressure compliance

| | |
|---|---|
| Compressibility of the liquid in the flow channel. | C₁ = V_{ch}κ |
| Volume of connecting channel V_{ch} | |
| $\begin{matrix}Air bubble in connecting channel . \\ Volume {V}_{b} = ( \frac{4}{3} ) {π ( {r}_{b} )}^{3} of air bubble \\ with radius rb\end{matrix}$ | ${C}_{2} = \frac{{p}_{0} {V}_{b}}{{( {p}_{0} - {Δp}_{load} )}^{2}}$ |
| Compliant materials in contact with the flow | ${C}_{3} = \frac{3 {V}_{soft} ( 1 - 2 v )}{E}$ |
| channels. | |
| Volume V_{SOFT} of package material with Youngs | |
| modulus E and Poisson ratio v | |

The resulting compliance is achieved by simply adding the contributions tabulated in Table 8. The RC time constant can be reduced, by decreasing the flow resistance of the pump. This can be done without compromising the stall pressure simply by increasing the number of pores. However, this will also decrease the electrical resistance across the pump, and hence for the same driving voltage, an increase of the current will be encountered, with a resulting increase in the Joule heating (see Table 7.) and electrode consumption (Eq. 7).

Furthermore by decreasing the number of pores and thereby reducing the electric resistance of the pump Rₚᵤₘₚ, the system becomes more sensitive to parasitic series resistance Rₛₑᵣᵢₑₛ. If the series resistance is large in comparison to the resistance of the pump, the actual voltage drop Uₚᵤₘₚ across the pump is no longer simply given by the voltage U supplied by an external voltage source. The actual voltage on the pump is given by:

$${U}_{pump} = \frac{{R}_{pump}}{{R}_{Series} + {R}_{Pump}} U , \qquad ( 11 )$$

This problem can be circumvented by current biasing the set-up.

In conclusion the desired dynamical range of the pumping can be achieved by choosing an appropriate number of pores, but with a trade off associated with increased Joule heating, electrode consumption and effects of parasitic series resistance.

As an example typical parameter values were used to compute some of the key parameters relevant for operation of the pump realized on a Silicon membrane. Obviously, a vast number of input parameters can be varied in such a calculation, and in order not to lose the overview, only the number of pores are varied in the shown tabulation of parameters. The given input parameters are shown in Table 9. The output is shown in Table 10.

TABLE 9
Given parameters used in the model calculation

| | |
|---|---|
| Aperture diameter d | 0.8 μm |
| Membrane thickness t | 10 μm |
| Side length of membrane L | 30 μm |
| Pitch size of pore array a | 5 μm |
| Driving voltage U | 50 V |
| Oxide thickness b | 1 μm |
| Thickness of substrate t_{die} | 380 μm |
| Side length of substrate L_{die} | 3 mm |
| Area of substrate-liquid interface A | 5 × 1.2 mm² |
| Volume of connecting channel V_{ch} | 200 μm × 1.2 mm × 5 mm |
| Radius of air bubble r_{b} | 50 μm |
| Volume of electrodes V_{electr.} | π × (1 mm)² × 15 μm |
| Flow conductance of load K_{load} | 10 pl s⁻¹ mbar⁻¹ |
| Effective Volume of package V_{pack} | 5 mm × 1 mm × 1 mm |
| Effective Youngs modulus of package | 2 GPa |
| $material \frac{E}{1 - 2 v}$ | |

TABLE 10
Results of the model calculations for a Si membrane

| N | I_{load} [pl/s] | ΔT [K] | τₚ = RₚC [ms] | Δt [min] |
|---|---|---|---|---|
| 9 | 255.2 | 3.0 | 1244 | 75 |
| 16 | 422.4 | 3.2 | 707 | 42 |
| 25 | 606.5 | 3.3 | 459 | 27 |
| 36 | 794.5 | 3.5 | 323 | 19 |
| 49 | 977.1 | 3.7 | 240 | 14 |
| 64 | 1148.5 | 3.9 | 186 | 10 |
| 81 | 1305.5 | 4.1 | 148 | 8.1 |
| 100 | 1446.9 | 4.4 | 121 | 6.5 |
| 121 | 1573.0 | 4.8 | 101 | 5.4 |
| 144 | 1684.7 | 5.1 | 85 | 4.5 |
| 169 | 1783.2 | 5.6 | 72 | 3.8 |
| 196 | 1870.0 | 6.0 | 62 | 3.2 |
| 225 | 1946.4 | 6.5 | 54 | 2.8 |
| 256 | 2013.7 | 7.0 | 48 | 2.4 |
| 289 | 2073.1 | 7.6 | 42 | 2.1 |
| 324 | 2125.7 | 8.2 | 37 | 1.9 |
| 361 | 2172.3 | 8.9 | 33 | 1.7 |
| 400 | 2213.8 | 9.6 | 39 | 1.5 |
| 441 | 2250.7 | 10.3 | 26 | 1.3 |
| 484 | 2283.7 | 11.2 | 24 | 1.2 |
| 529 | 2313.3 | 12.1 | 21 | 1.1 |
| 576 | 2339.9 | 13.0 | 19 | 1.0 |
| 625 | 2363.8 | 14.1 | 17 | 0.9 |
| 676 | 2385.5 | 15.2 | 16 | 0.8 |
| 729 | 2405.1 | 16.3 | 14 | 0.7 |
| 784 | 2422.8 | 17.6 | 13 | 0.7 |
| 841 | 2439 | 19.0 | 12 | 0.6 |
| 900 | 2453.7 | 20.5 | 11 | 0.6 |
| 961 | 2467.2 | 22.0 | 10 | 0.5 |

As a second example we reproduce a similar calculation for a pump realized on a Si₃N₄ membrane.

The given input parameters are shown in Table 11. The output is shown in Table 12.

TABLE 11
Given parameters used in the model calculation

| | |
|---|---|
| Pore diameter d | 0.8 μm |
| Membrane thickness t | 3 μm |
| Side length of membrane L | 30 μm |
| Pitch size of pore array a | 5 μm |
| Driving voltage U | 50 V |
| Oxide thickness b | 1.4 μm |
| Thickness of substrate t_{die} | 380 μm |
| Side length of substrate L_{die} | 3 mm |
| Area of substrate-liquid interface A | 5 × 1.2 mm² |
| Volume of connecting channel V_{ch} | 200 μm × 1.2 mm × 5 mm |
| Radius of air bubble r_{b} | 50 μm |
| Volume of electrodes V_{electr.} | π × (1 mm)² × 15 μm |
| Flow conductance of load K_{load} | 10 pl s⁻¹ mbar⁻¹ |
| Effective Volume of package V_{pack} | 5 mm × 1 mm × 1 mm |
| Effective Youngs modulus of package | 2 GPa |
| $m aterial \frac{E}{1 - 2 v}$ | |

TABLE 12
Results of the model calculations for a Silicon nitride membrane

| N | I_{load} [pl/s] | ΔT [K] | τₚ = RₚC [ms] | Δt [min] |
|---|---|---|---|---|
| 9 | 363.7 | 22.8 | 56 | 44 |
| 16 | 409 | 23.0 | 26 | 25 |
| 25 | 434.0 | 23.4 | 16 | 16 |
| 36 | 448.9 | 23.7 | 11 | 11 |
| 49 | 458.4 | 24.2 | 8.2 | 8.0 |
| 64 | 464.8 | 24.7 | 6.3 | 6.1 |
| 81 | 469.2 | 25.4 | 4.9 | 4.7 |
| 100 | 472.5 | 26.1 | 3.9 | 3.8 |
| 121 | 474.9 | 26.9 | 3.2 | 3.1 |
| 144 | 476.8 | 27.8 | 2.6 | 2.6 |
| 169 | 478.3 | 38.8 | 2.2 | 2.2 |
| 196 | 479.4 | 29.9 | 1.9 | 1.8 |
| 225 | 480.4 | 31.1 | 1.6 | 1.6 |
| 256 | 481.1 | 32.5 | 1.4 | 1.4 |
| 289 | 481.8 | 34.0 | 1.2 | 1.2 |
| 324 | 482.3 | 35.6 | 1.0 | 1.0 |
| 361 | 482.8 | 37.4 | 0.9 | 0.9 |
| 400 | 483.2 | 39.4 | 0.8 | 0.8 |
| 441 | 483.5 | 41.6 | 0.7 | 0.7 |
| 484 | 483.8 | 44.0 | 0.6 | 0.6 |
| 529 | 484.0 | 46.7 | 0.5 | 0.6 |
| 576 | 484.2 | 49.7 | 0.5 | 0.5 |
| 625 | 484.4 | 53.0 | 0.4 | 0.4 |
| 676 | 484.6 | 56.6 | 0.4 | 0.4 |
| 729 | 484.7 | 60.7 | 0.3 | 0.3 |
| 784 | 484.9 | 65.3 | 0.3 | 0.3 |
| 841 | 485.0 | 70.4 | 0.3 | 0.3 |
| 900 | 485.1 | 76.0 | 0.2 | 0.2 |
| 961 | 485.1 | 82.4 | 0.2 | 0.2 |

In conclusion the calculations illustrates the basic mechanisms of pump operation. It can be seen, that while the flow through the load is only negligibly affected by the number of apertures, the thermal properties, the transient response times, and the electrode consumption times are dramatically affected when the number of apertures is changed. The heat sinking is particularly improved when the thin silicon nitride membrane is replaced with a thick Si membrane.

Preliminary experiments have been performed on pumps fabricated with a silicon nitride membrane, which is different from the preferred embodiment of the invention, where the bulk part of the membrane is made from Si allowing for much better heat sinking (thicker membrane and higher thermal conductivity). The number of apertures was 100 in the tested devices. The fabrication method resulted in a membrane thickness of approximately 3 μm consisting of a material with a heat conductivity comparable to SiO₂ (see Table 4.). The tested sieve pumps were assembled into a plastic housing shown in FIG. 6. After assembly of the housing, the die was placed into a recess and glue was wicked in to seal it. The channel below the membrane area is 1 mm diameter, thus preventing any glue wicking into the 50 μm×50 μm membrane area. After the die was sealed into the recess, an additional small amount of glue was added to form a bead around the edge of the die, and thus ensure complete sealing. In FIG. 6 (15) is a platinum electrode, (16) an Ag/AgCl internal electrode, (17) the plastic housing, (18) the flow channel, (19) the sieve pump, and (20) the monitoring capillary tube. Pumps were tested with standard extra cellular buffer solution (approximately 150 mM NaCl) for mobility (or zeta potential) against a nominally zero back pressure—the pressure drop down the monitoring capillary has been calculated for appropriate liquid flow rates and found negligible. Flow rates were measured by monitoring the movement of a meniscus under a traveling microscope. Measurements were made at various applied voltages, usually covering a complete voltage sweep. The order of this is usually stepping from zero, through the negative¹ voltages to the minimum voltage, back through these to zero and similarly for the positive voltages. This gives information on the linearity of the pump—and checks that the effect is truly EOF—and also on its repeatability. A least squares fit is taken to the graph of flow rate vs. voltage, and this is used to calculate the zeta potential and EOF mobility. A second test was carried out to determine the stall pressure. Initially this was done by sealing the end of the monitoring capillary, and pumping to compress or elongate the air bubble formed in the end.

Later tests were done using a computer controlled gas pressure pump, and determining the null point where a given pressure is required to stop the flow generated by the pump. Again, this was monitored under a traveling 15 microscope. Where pump stall pressures were higher than the range of the gas pressure pump (450 mbar), the flow rate was measured at a number of back pressures and the graph extrapolated to give the stall pressure. This procedure was also carried out to confirm that the experimental method of finding the null point can give accurate stall pressures. The equivalent stall pressure measurements made by determining the flow rate null point were 85 mbar and −95 mbar for 200V and −200V, respectively.

| | | Zeta | +Ve stall | −Ve stall | |
|---|---|---|---|---|---|
| | μ_{EOF} | potential | pressure | pressure | Voltage |
| Device | [10⁻⁴ cm²V⁻¹s⁻¹] | [mV] | [mbar] | [mbar] | [V] |
| SC01 | 0.456 | 5.86 | | | |
| SC01 | 0.474 | 6.09 | | | |
| SC03 | 0.520 | 6.69 | | | |
| SC05 | 0.517 | 6.64 | 200 | −50 | 5 |
| SC05 | | | 425 | −190 | 10 |
| SC05 | | | 450 | −450 | 25 |
| SC06 | | | 450 | −220 | 50 |
| SC07 | 0.422 | 5.43 | 76 | −60 | 10 |
| SC07 | | | 260 | −103 | 25 |
| Mean | 048 | 6.14 | | | |
| St. Dev. | 0.04 | 0.53 | | | |
| RSD | 9% | 9% | | | |

¹Throughout the document, a negative voltage is denoted as one where the external platinum electrode is held at a negative potential with respect to the Ag/AgCl electrode, and the direction of fluid flow is equivalent to suction up the monitoring capillary back into the pump.

During tests, at voltages greater than about 50V, bubbles could be seen forming on the surface of the membrane. This was assumed to be a result of the high power dissipation in the membrane, causing the water to boil. In many cases this resulted in fracture of the membrane. In conclusion, if sieve chips made with thin silicon nitride membranes are to be used as EOF pumps, it can only be at very low voltages—say 10-30V. Heat sinking should be improved in order to avoid boiling of liquid. In addition to improve the heat sink properties it should help the fragility of the membrane if this was thicker, with the number of holes adjusted to suit the flow rate required.

To avoid the heating effects discussed above, pumps consisting of silicon have been fabricated and tested with respect to pumping capacity. The fabrication technique is the same as that described herein above and the dimensions of the final pumps and the measurement set-up is as displayed in table 9, with the exception that the silicon gaskets used in the experiment had a Young's modulus of approximately IMP.

FIG. 8 displays a drawing of the top and bottom part of the PolyEtherEtherKetone (PEEK) housing, ThermoPlast Elastomer (TPE) gasket and Si chip. In the experiments pressure supplied by the pump was measured as a function of time. The pressure was measured with a RS V9637 pressure transducer.

On FIG. 9 a typical experiment is plotted for a 200 aperture pump working at three different currents I=1 mA, 0.5 mA and 0.25 mA. As is observed, over a period of hundreds of seconds the pump reaches a maximum pressure of approximately 150 mbar. At that point, after the pump has been running for several minutes, a bubble is probably formed on the backside of the pump due to electrolysis at the electrode. The large compressibility of the gas bubble prohibits the pump from increasing the pressure even further. In between the measurements the pump was vented giving rise to the steep pressure decreased. The insert in FIG. 9, displays the rise time of the pump. It is clearly seen that the rise time depends linear on the current which also is expected. The extremely long time constants observed in these experiments can be ascribed to the very soft gaskets material used in the holder of the pump.

To conclude, if the channels connecting the sieve pump are in contact with any soft materials e.g. TPE gaskets, long time constants (hundreds of seconds) are to be expected. To avoid these response times, care should be taken only to apply hard materials in constructing the holder for the chip.

### REFERENCES

[1] Oldham, H. B, Myland, J. C., “Fundamentals of electrochemical science”, Academic Press; ISBN: 0-12-525545-4.

[2] Madou, M., “Fundamentals of Microfabrication”, 2^{nd} Ed. CRC Press; ISBN: 0-8493-0826-7.

[3] Triton, D. J., “Physical fluid dynamics”, Van Nostrand Reinhold (UK); ISBN: 0-442-30132-4

[4] Rohsenow, W. M., Hartnett, J. P., Cho, Y. I., “Handbook of heat transfer”, 3^{rd} Ed. McGraw Hill; ISBN: 0-07-053555-8.

[5] Sedra, A. S., Smith, K. C., “Microelectronic circuits”, 4^{th} Ed. Oxford University Press; ISBN: 0-19-511690-9.

[6] Danish Institute of Fundamental Metrology, Certificate no. CM0202.

[7] Lide, David R., “Handbook of Chemistry and Physics” 78'th Edition, CRC.

[8] Højgaard Jensen, H, “Defonnerbare stoffers mekanik”, 1^{st} Ed., Gjellerup 1968.

1. An electroosmotic flow pump for generating a flow in an electrolyte from an inlet to an outlet in a channel, the electroosmotic flow pump comprising a housing with the channel for holding the ionic solution, a membrane separating the channel in a first part in contact with the inlet and a second part in contact with the outlet, the membrane comprising a plurality of perforations having inner surface parts with a finite zeta potential in an 130-160 mM aqueous electrolyte with pH value in the interval 7-7.5, one or more first electrodes in electrical contact with electrolyte held in the first part of the channel and one or more second electrodes in electrical contact with electrolyte held in the second part of the channel, means for creating an electric potential difference between the first and second electrodes.

2. An electroosmotic flow pump according to claim 1, wherein the membrane is formed from silicon nitride.

3. An electroosmotic flow pump according to claim 2, wherein the thickness of the membrane falls within the range of 50 to 400 nm.

4. An electroosmotic flow pump according to claim 1, wherein the membrane is formed from oxidised silicon.

5. An electroosmotic flow pump according to claim 4, wherein the thickness of the membrane falls within the range 1 to 20 μm.

6. An electroosmotic flow pump according to claim 4 or claim 5 wherein the thickness of the membrane is more than 3 μm.

7. An electroosmotic flow pump according to claim 1, wherein the membrane is formed from glass or silica.

8. An electroomostic flow pump according to claim 7, wherein the thickness of the membrane falls within the range of 2 to 200 μm.

9. An electroosmotic flow pump according to any one of the preceding claims, wherein the number of perforations in the membrane is in the interval 4-10000, and the inner radii of the perforations fall within the interval 0.1-5 μm.

10. An electroosmotic flow pump according to any one of the preceding claims, having a stall pressure in excess of 200 mbar for a driving voltage below 50 V.

11. An electroosmotic flow pump according to any one of the preceding claims, wherein an average distance between any perforation and its closest neighbour is in the interval 2-100 μm.

12. An electrosomotic flow pump according to any one of the preceding claims, wherein the membrane comprises a material with a thermal conductivity in excess of 1.5 W m⁻¹ K⁻¹.

13. An electroosmotic flow pump according to any one of the preceding claims, the housing comprising a material with a Young's modulus in excess of 1 Mpa and a Poisson ratio in the interval 0.4-0.5.

14. A membrane forming part of an electroosmotic flow pump according to any one of claims 1 to 13.

15. A method of manufacturing an electroosmotic flow pump according to any one of claims 1 to 13, the method comprising the steps of:
forming the membrane with a predetermined number of perforations each having an inner radius of predetermined size such that in use of the pump, a maximum volumetric flow rate in excess of 1 n1 s⁻¹ is obtained when the pump is driven at a driving voltage of less then 50V.

16. A method according to claim 15 wherein the number of perforations in the membrane falls within the range 4-10000, and the inner radii of the perforations falls within the range 0.1-5 μm.

17. An electroosmotic flow pump substantially as hereinbefore described with reference to the accompanying drawings.

18. A membrane substantially as hereinbefore described with reference to the accompanying drawings.

19. A method substantially as hereinbefore described with reference to the accompanying drawings.
